(19) United States
(12) Patent Application Publication
(10) Pub. No.: US 2004/0034807 A1
(43) Pub. Date: Feb. 19, 2004

(54) Roving servers in a clustered telecommunication distributed computer system

(75) Inventor: Bruce D. Rostowfske, Walnut, CA (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: GNP Computers, Inc., Monrovia, CA (US)

(21) Appl. No.: 10/218,767

(22) Filed: Aug. 14, 2002

(51) Int. Cl. G06F 11/16

(52) U.S. Cl. 714/4; 709/201; 709/208

(57) ABSTRACT

A distributed telecommunications system includes a master server, a back-up server and a plurality of computing nodes. The back-up server monitors the operational status of the master server, via a heartbeat process or a polling process. If the master server fails operationally, the back-up server assumes the role of the master server. The new master server requests a new back-up server via a tuple space command. One of the available computing nodes assumes the role of the new back-up server.

### BACKGROUND OF THE INVENTION

The present invention relates to distributed computer processing systems, and more particularly, to a clustering model for plural computing units utilizing a virtual shared memory to provide real-time responsiveness and continuous availability.

With the constantly increasing complexity of scientific, engineering and commercial applications, there is a high demand for systems providing large amounts of computing power. For many such applications, mainframe computer systems represent a traditional solution in view of their ability to perform enormous numbers of computations at very high speeds. Such mainframe computers have significant drawbacks, chiefly being their high cost due in part to their use of highly customized hardware and software developed specifically for each particular application. Moreover, mainframe computers cannot be easily scaled to provide additional capacity as demand increases. An additional drawback of mainframe computers is that they represent a single point of failure. It is necessary to provide redundant computer system for applications demanding a high degree of system availability, such as telecommunications applications, thereby further increasing the cost and complexity of such systems.

As an alternative to mainframe computer systems, distributed computing systems have been developed in which a plurality of computing units (e.g., personal computers or workstations) are connected to a client-server network. In a distributed computing system, the computational power of the overall system is derived from the aggregation of separate computing units. The primary advantages of such distributed systems are reduced cost and scalability, since each computing unit may be provided using standard commercial hardware and software, and the computing system may be expanded as necessary by simply adding more computing units to the network. A drawback of distributed computing systems is that it is difficult to develop software applications that can coordinate the disparate processes performed on the separate computing units. These processes include the sharing of data between the computing units, the creation of multiple execution units, the scheduling of processes, and the synchronization of the processes. Another drawback of distributed computing systems is providing fault tolerance. When the computing units are executing long-running parallel applications, the probability of a failure increases as execution time or the number of computing units increases, and the crash of a single computing unit may cause the entire execution to fail.

Various fault-tolerant parallel programming models have been developed to address these and other drawbacks of distributed computing systems. One such model is Linda, a parallel computation model based on a virtual shared memory. In Linda, processes in an application cooperate by communicating through the shared memory, referred to as “tuple space.” Each “tuple” within the tuple space contains a sequence of typed data elements that may take any of various forms, including integers, floats, characters, arrays of data elements, and the like. Processes access tuple space using four basic operations, including: “out” for tuple creation; “eval” for process creation; “in” for destructive retrieval; and “rd” for non-destructive retrieval. Other known tuple space operations may also be included. An advantage of Linda is that communication and synchronization via the tuple space are anonymous in the sense that processes do not have to identify each other for interaction. A variant of Linda, known as Persistent Linda or PLinda, supports fault tolerance and is applicable for using idle computing units for parallel computation. PLinda adds a set of extensions to the basic Linda operations that provides fault tolerance by periodically checkpointing (i.e., saving) the tuple space to non-volatile memory (i.e., disk storage). This way, the tuple space can be restored in the event of a catastrophic system failure.

While such fault-tolerant parallel programming models using virtual shared memory are advantageous for solving certain types of mathematical and/or scientific problems, they are impractical for many other real-time applications. Specifically, certain applications require a high level of computation accuracy, such as analysis of high energy physics data or calculation of pricing for financial instruments. For these applications, a lower level of system availability to accommodate periodic maintenance, upgrade and/or system failures in an acceptable trade-off as long as the computation results are accurate. The Linda or PLinda programming model is well suited for these applications. On the other hand, certain real-time applications require a high level of system availability and can therefore accept a somewhat lower level of computation accuracy. For example, it is acceptable for a telecommunications server to occasionally drop a data packet as long as the overall system remains available close to 100% of the time. Such highly demanding availability requirements allow only a very limited amount of system downtime (e.g., less than three minutes per year). As a result, it is very difficult to schedule maintenance and/or system upgrades, and any sort of global system failure would be entirely unacceptable.

Accordingly, a critical need exists for a distributed computing system having a fault-tolerant parallel-programming model that provides real-time responsiveness and continuous availability.

### SUMMARY OF THE INVENTION

The present invention is directed to a distributed computing system that provides real-time responsiveness and continuous availability while overcoming the various deficiencies of the prior art.

An embodiment of the distributed computing system comprises a primary server having a primary, virtual shared memory and a back-up server having a back-up virtual shared memory. The primary server periodically provides a state table to the back-up server in order to synchronize the virtual shared memory and the back-up virtual shared memory. A plurality of client computer resources are coupled to the primary server and the back-up server through a network architecture. The client computer resources further comprise plural worker processes each adapted to independently perform an operation on a data object disposed within the primary virtual shared memory without a predetermined assignment between the worker process and the data object. Upon unavailability of the primary server, the worker process performs the operation on the corresponding data object in the back-up virtual shared memory within the back-up server. The client computer resources further comprise plural input-output (I/O) ports adapted to receive incoming data packets and transmit outgoing data packets.

There are plural types of worker processes, and each worker process may be adapted to perform a distinct type of function. One type of worker process further comprises an input worker process adapted to retrieve an incoming data packet from an I/O port and place a corresponding data object on the primary virtual shared memory. Another type of worker process further comprises an output worker process adapted to remove a data object from the primary virtual shared memory and deliver a data packet to an I/O port. The remaining worker processes operate by grabbing a data object having a predefined pattern from the said primary virtual shared memory, processing the data object in accordance with a predefined function, and returning a modified data object to the primary virtual shared memory.

In another embodiment of the distributed computing system, roving servers are implemented. The distributed computing system, in this embodiment, includes a plurality of computing nodes, any of which can be a master server or a back-up server to the master server. At start-up, none of the nodes are assigned as a master server or a back-up server. Each of the nodes implements a discovery protocol to discover whether a master server exists. If a master server is found to exist, then the node implementing the discovery procedure will enter a passive mode wherein it performs a number of procedures, including a search for the need for a back-up server. If it is determined that a back-up server is needed, the node declares itself a back-up server.

If the node determines that no master server exists, then the node declares itself a master server, and seeks a back-up server. Once another node determines that a back-up server is needed, and then declares itself to be the back-up server, then the distributed computing system performs its operations. During this time, the master server and the back-up server perform a watchdog operation or a heartbeat operation to monitor the availability of the back-up server and the master server, respectively.

A more complete understanding of the distributed computing system clustering model will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram illustrating an embodiment of the distributed computing system clustering model in accordance with the present invention.

FIG. 2 is a logic diagram illustrating transactions involving data objects within virtual shared memory.

FIG. 3 is a flow chart illustrating an exemplary worker process performed on a data object.

FIG. 4 is a flow chart illustrating an exemplary input worker process performed on an incoming data packet.

FIG. 5 is a flow chart illustrating an exemplary output worker process performed on an outgoing data packet.

FIG. 6 is a block diagram of the clustered, distributed computing system.

FIGS. 7 to 9 are flow charts of the steps performed by each node in the distributed computing system to determine a master server and a backup server.

FIGS. 10 and 11 illustrate a heartbeat process.

### DETAILED DESCRIPTION

The present invention satisfies the need for a distributed computing system having a fault-tolerant, parallel-programming model that provides real-time responsiveness and continuous availability.

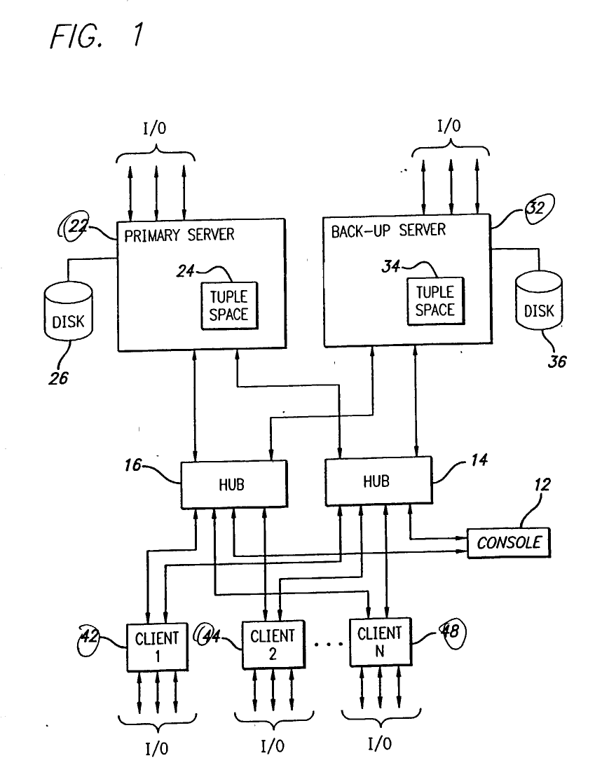

Referring first to FIG. 1, a block diagram is illustrated of a distributed computing system clustering model in accordance with an embodiment of the present invention. The distributed computing system comprises plural nodes including a primary server 22, a back-up server 32, and a plurality of clients (1 through N) 42, 44, 48 that are connected together in a local area network through hubs 14, 16. The primary and back-up servers 22, 32 communicate with each other and with the clients 42, 44, 48 using an application-data-exchange protocol that implements the semantics of tuple space operations (described below). This tuple space application protocol relies on and is compatible with an underlying conventional network protocol, such as Ethernet or Token Ring. The primary server 22, back-up server 32 and clients 42, 44, 48 each represents a communication node of the network.

Each of the communication nodes of the distributed computing system of FIG. 1 may physically comprise a separate computing unit (e.g., personal computer, workstation, and the like), or plural communication nodes may be provided by a separate processes executing within a single computing unit. For example, the primary server 22 and one or more of the clients 42, 44, 48 may actually be provided within a single computing unit. Each such computing unit typically comprises a processor and random access memory (RAM). As used herein, the term “processor” is intended to broadly encompass microprocessors, digital signal processors (DSPs), application specific integrated circuits (ASICs), field programmable gate arrays (FPGAs), and the like. Each of the clients 42, 44, 48, as well as the primary server 22 and the back-up server 32, further include plural input/output (I/O) ports. The I/O ports allow data and/or signals to be provided to/from the network through any node. In turn, the I/O ports may then be coupled to other external systems, such as other computer networks or the Internet. A console 12 is coupled to the primary and back-up servers 22, 32 through one of the nodes 14, 16, and comprises a process executing on a computing unit similar to the clients 42, 44, 48. Unlike the clients, the console 12 provides the specific function of allowing a user to enter management commands and information into the network, and to monitor the operational status of the network. The console 12 may be further coupled to an input device (e.g., keyboard, mouse, scanner, etc.), and a video monitor or other visual display device to provide a visual output to the user.

The primary server 22 further includes a non-volatile memory, i.e., disk storage 26, and a random access memory (RAM) that is accessible by each of the clients 42, 44, 48 as well as the console 12 using the tuple space application protocol, in order to provide a virtual shared memory (also referred to herein as tuple space) 24. The server disk and RAM are, however, not required. If access from the client nodes is required, it can be accomplished by agent application. Similarly, the back-up server 32 further includes a non-volatile memory, e.g., disk storage 36, and a random access memory (RAM) that is also accessible by each of the clients 42, 44, 48 as well as the console 12 in order to provide a back-up virtual shared memory (i.e., back-up tuple space) 34. As will be further described below, the virtual shared memory 24 and back-up virtual shared memory 34 each provides a space within which data objects (i.e., tuples) may be placed. The tuples may be heterogeneous, meaning that different types of data objects may share the virtual shared memory 24. The virtual shared memory 24 of the primary server 22 and the back-up virtual shared memory 34 of the back-up server 32 are synchronized together by communication of a state table between the primary server 22 and back-up server 32. The tuple space may be used as a programming interface for a relational database, cluster database, data object repository, and the like, and portions of the virtual shared memory 24, 34 may rely on implementations of those database types. Whenever the state of a tuple within the tuple space on the primary server 22 is changed, i.e., by adding, changing or deleting a tuple, the state table is updated so that the tuple space on the back-up server 32 reflects the change. The state table may also be stored in the disk memory 26 to provide a permanent archive of the tuple space to be accessed in the event of failure of one or both of the primary server 22 and the back-up server 32.

The clients 42, 44, 48 each provide processing resources for retrieving, storing and processing the data objects (i.e., tuples) within the tuple space. There is no assigned relationship between the clients and the tuples, so that any client may access any tuple as long as there is a match between the type of worker process executing on the client and the particular tuple (described in greater detail below). Additional processing resources may be added to the network by simply connecting additional clients to one of the hubs 14, 16. Moreover, the computing units that provide the clients 42, 44, 48 need not be equal in terms of processing power and/or speed.

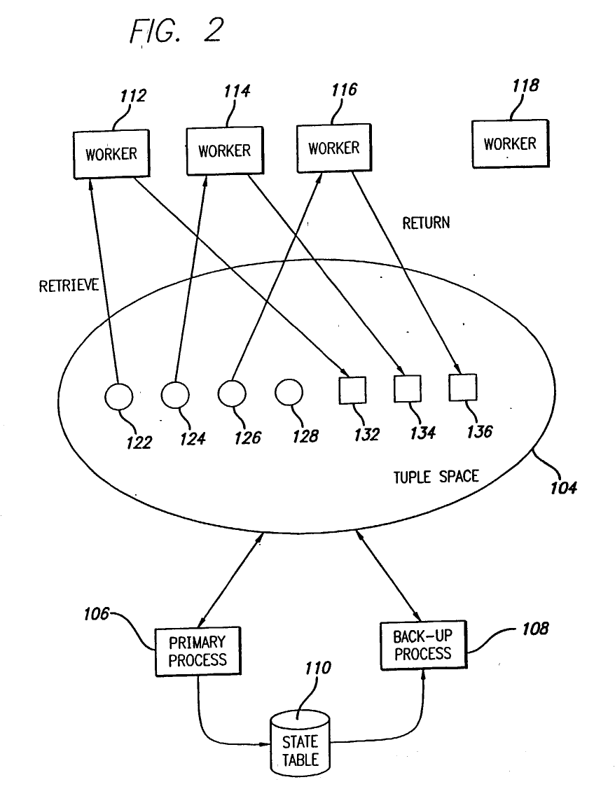

Referring now to FIG. 2, a logic diagram illustrates exemplary operations involving data objects within the virtual shared memory or tuple space 104. The tuple space 104 contains a plurality of tuples, including a first type of tuple 122, 124, 126, 128 (represented as circles) all having a common data format, and a second type of tuple 132, 134, 136 (represented as squares) all having a common data format distinct from that of the first type of tuple. Although two types of tuples are illustrated for purposed of simplicity, it should be appreciated that there is no limit to the number of types of tuples that may be present in the tuple space. Each type of tuple has a distinctive data format, and may be utilized to represent a different type of information. The logic diagram further illustrates plural worker processes 112, 114, 116, 118 that may be executing on one or more of the clients (described above). Each worker process performs a type of operation on a tuple within the tuple space 104. For example, worker process 112 retrieves a first type of tuple 122 from the tuple space 104, then performs some processing on the data contained within the tuple, and then returns a second type of tuple 132 to the tuple space 104. In the exemplary second type of tuple 132, the data contained in the tuple has between transformed from a first state to a second state. As described above, the primary process 106 operating on the primary server 22 maintains that state of the tuple space 104, and provides a state table 110 to the back-up process 108 operating on the back-up server. A copy of the state table 110 may be transferred every time there is a change in state of the tuple space 104.

With certain critical types of data objects, such as system configuration settings or user account and billing information, it may be desirable to store tuples in such a way that they can be recovered in the event of a failure of both primary and back-up servers 22, 32. For this purpose, a tuple may be identified as “persistent” by the worker process that creates it; the primary and back-up servers 22, 32 store the contents of such persistent tuples in non-volatile memory, such as disk or flash memory, in addition to the copy in the virtual shared memory. On recovery from a failure of one or both servers, the persistent tuples are re-constituted in virtual shared memory from the data stored in non-volatile memory.

The operations that are performed on the tuples within the tuple space may be grouped into transactions. More particularly, a transaction comprises a set of operations having the properties of atomicity, isolation and durability. Atomicity refers to the characteristic that all operations within a transaction necessarily take effect (i.e., commit), or none execute (i.e., abort). Thus, there can be no partial execution of a transaction. Isolation refers to the characteristic that even if there are multiple, concurrent transactions in progress, operations within one transaction take effect as if there were no other transactions running at the same time. Durability refers to the characteristic that when a transaction commits, its effects are retained in the fact of any failures that may occur later. It should be appreciated that a transaction is only durable if the tuple is identified as being persistent, i.e., its contents are stored on disk or other stable media. When applied properly, a transaction ensures that desired data consistency conditions are maintained in the tuple space, even in the event of unanticipated hardware or software failures. This makes recovery from failures more effective (and, in some cases, possible) than would otherwise be the case, and contributes to the high availability of the system as will be further described below. Moreover, the data transfer protocol between the primary and back-up servers 22, 32 and between the clients 42, 44, 48 and the back-up server during recovery from a failure of the primary server, ensures that the transaction properties hold in the event of a failure of a client or the primary server.

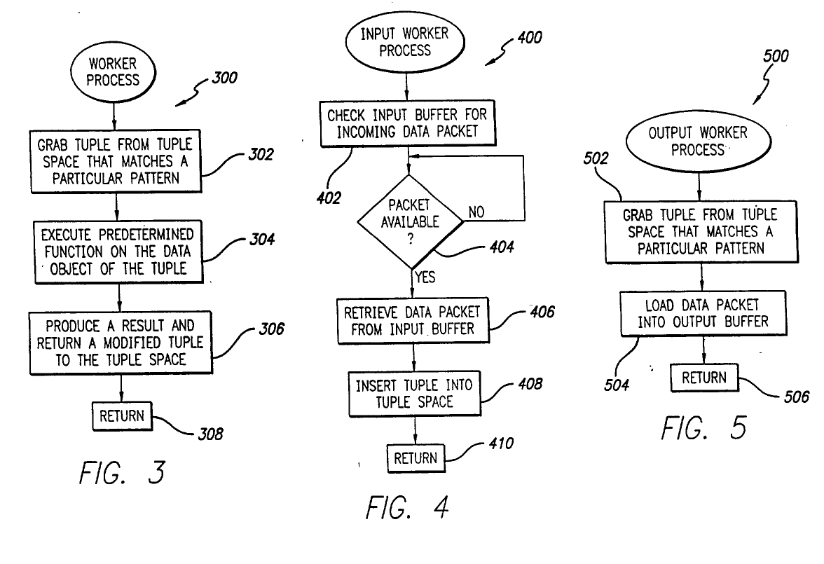

FIG. 3 illustrates an exemplary worker process 300 that comprises a simplified transaction. At step 302, the worker process grabs an available tuple from the tuple space 104. This step may execute the Linda “in” or “rd” operations whereby a typed pattern for a tuple is selected as an argument, and a tuple is retrieved from the tuple space 104 that matches the typed pattern in an associative manner. If the “in” operation is performed, the tuple is destroyed, i.e., permanently removed, from the tuple space. Conversely, if the “rd” operation is performed, a copy of the tuple remains in the tuple space. As noted above, there is no assignment or mapping of worker processes to the tuples, and any worker process may grab any available tuple that matches the pattern defined by the worker process. At step 304, the data contained within the tuple is processed in some manner by executing a predetermined function on the data. Plural worker processes may perform the same function, or each worker process may perform a unique function. In a preferred embodiment of the invention, the tuple space permits multi-threading and a single worker process may thereby perform multiple functions. At step 306, the worker process produces a result and returns a new tuple to the tuple space 104. This step may execute the Linda “out” operation whereby a sequence of typed expressions is taken as an argument. A new tuple is constructed from the sequence, and is inserted into the tuple space. The worker process then returns to the beginning and repeats itself. In this manner, the worker processes will continually grab available tuples and process them accordingly. It should be appreciated that more complex transactions may include multiple “in,” “rd” and “out” operations.

Ordinarily, the worker processes do not maintain any state data regarding the tuple. In the event of a failure of a worker process, any intermediate data products formed within the process may be lost. By virtue of the transaction properties, however, the contents of tuple space will reflect either the complete intended effect of the worker process, or the conditions that prevailed just before the worker process began to handle the transaction. In the latter case, another worker process (of the same type) can handle the transaction.

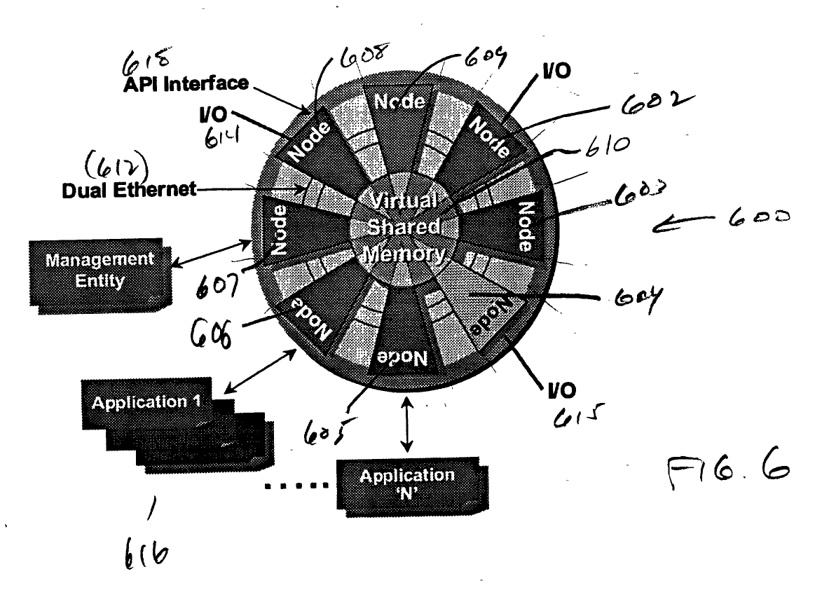

Since the distributed computing system is intended to operate in a real-time processing environment, specific worker processes are provided to perform input and output functions. FIG. 4 illustrates an exemplary input worker process 400 with reference to the block diagram of FIG. 1. As known in the art, an incoming data packet received at one of the I/O ports of the primary server 22, back-up server 32 or the clients 42, 44, 48 would be written to a memory space that provides an input buffer. The operating systems of the communication nodes typically include Application Program Interfaces (API) adapted to handle the retrieval of data packets from the input buffer. As step 402, the input worker process checks the input buffer of the I/O ports for the presence of a received data packet. Next, at step 404, the input worker process determines whether a data packet is present. If no data packet is present, the input worker process will wait until a data packet arrives. When a data packet arrives at the input buffer, the process passes to step 406 at which the data packet is retrieved from the input buffer. Then, at step 408, the data packet is converted into a tuple and is inserted into the tuple space 104 using a Linda “out” operation. The input worker process then returns to the beginning and repeats again. By operation of the input worker process, any incoming data packets received by the distributed computing system from an external system are moved into the tuple space 104 to enable further processing.

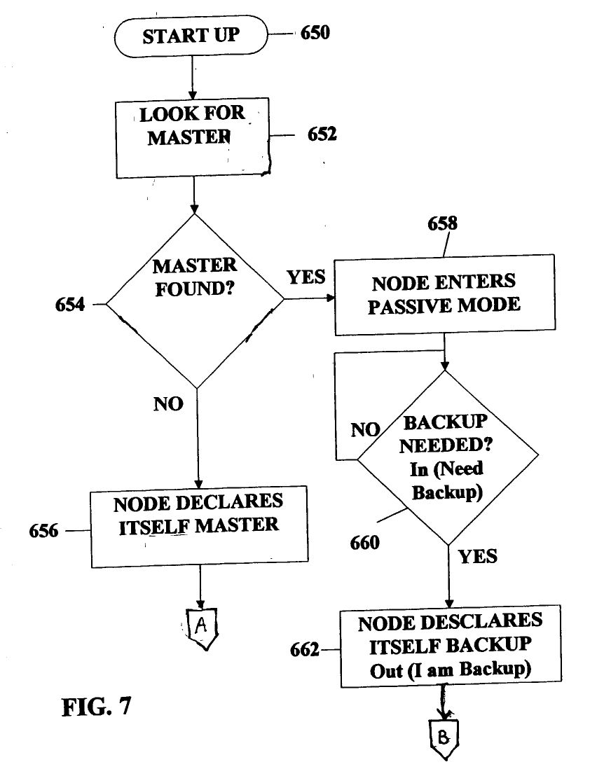

FIG. 5 illustrates an exemplary output worker process 500 with reference to the block diagram of FIG. 1. As known in the art, an outgoing data packet to be transmitted from one of the I/O ports of the primary server 22, back-up server 32 or the clients 42, 44, 48 would be written to a memory space that provides an output buffer. The operating systems of the communication nodes typically include device drivers adapted to handle the loading of outgoing data packets into the output buffer. At step 502, the output worker process grabs an available tuple from the tuple space 104 using the Linda “in” operation whereby a tuple is retrieved from the tuple space 104 that matches the typed pattern in an associative manner. Next, at step 504, the output worker process loads a data packet containing the data of the retrieved tuple into the output buffer. The output worker process then returns to the beginning and repeats again. By operation of the output worker process, any tuples that contain fully processed data are converted into data packets and transmitted from the distributed computing system to an external system.

As described above, communication between any of the nodes and the tuple space is performed in accordance with known network protocols. In accordance with such protocols, data frames communicated between the nodes specify a destination address in the header of the frame. Referring again to FIG. 1, when a client transmits a data frame to the primary server 22, such as to write a tuple to the tuple space, the header will identify the primary server in the frame header. The sending node starts a timer with the transmission of the data frame. The primary server 22 will return an acknowledgement back to the client reflecting the satisfactory receipt of the data frame. In the event that the primary server 22 fails during the operation of the distributed computing system, the acknowledgement will not be returned to the sending node. If an acknowledgement is not received within a predetermined period of time determined by the timer, the sending node will resend the data frame specifying he back-up server 32 in the frame header. Since the back-up tuple space 34 is identical to the primary tuple space 24, the distributed computing system continues to operate without impact even though the primary server 22 has failed. When the primary server 22 returns to operational status, the back-up server 32 passes a copy of the state table back to the primary server to again synchronize the respective tuple spaces 24, 34. Alternatively, in the case of roving servers, which will be described in greater detail, the back-up server detects the lack of acknowledgement, and then sends a message to all clients telling them that it is now the primary server and to restart operations at a defined safe point.

There are significant advantages to the distributed computing system described above. Since there is no assignment between worker processes and tuples, work units are processed as part of a virtual process thread. In traditional computing architectures, a work unit is processed as part of a predefined thread of instructions. Traditional multitasking environments have multiple threads of execution taking place concurrently within the same program with each thread processing a different transaction or message. In contrast, the tuple space of the present distributed computing system provides a virtual process thread whereby a work unit may be acted upon or processed by plural worker processes physically executing on different computing units. This virtual process thread provides distinct advantages over traditional computing architectures in terms of reliability, scalability and load balancing.

Specifically, the distributed computing system provides high reliability and continuous availability in view of the redundant tuple spaces 24, 34 on the primary and back-up servers 22, 32, respectively. If one of the primary and back-up servers 22, 32 becomes unavailable, such as due to a failure or routine maintenance, the distributed computing system keeps operating without a noticeable impact on performance. A failure of any of the clients 42, 44, 48, or the worker processes executing thereon, would only affect the individual tuples being processed by that client, and would have no effect on the overall system. In the worst case, an individual incoming data packet might be lost (e.g., corresponding to a single telephone call), which is acceptable for many applications.

Moreover, the distributed computing system provides natural load balancing. Since there is no assignment between worker processes and tuples, the work available on the tuple space becomes distributed between the available client computing resources as a natural outgrowth of the autonomous character of the worker processes. Similarly, additional worker processes can be created as needed to accommodate changes in load. Individual worker processes may be adapted to provide a function of measuring the throughput rate of data through the system, such as by measuring the amount of time that a tuple remains in the tuple space before being grabbed by a worker process. If the amount of time exceeds a predetermined limit (i.e., too much work and not enough workers), the worker process may launch an additional worker process; conversely, if the amount of time is below a predetermined limit (i.e., too little work and too many workers), the worker process may terminate a worker process. This way, the throughput rate can be regulated.

The nature of the data transfer protocol between the clients and the servers, as well as the structure of the server process, permits “soft” real time processing. Unlike “hard” real time processing in which there are strict time limits in the processing of work units, the present distributed computing system attempts to ensure that any delay between the receipt of a request packet arriving at an I/O port and a responsive packet being transmitted from an I/O port is kept below a tunable limit for most transactions. This is accomplished by regulating the number of worker processes that are operative on the tuple space, wherein additional worker processes are added if processing delays exceed some predetermined limit. “Soft” real time processing is acceptable for many types of applications that don't require processing within strict time limits, such as telecommunications applications.

The distributed computing system also provides a high degree of scalability. Client computing resources can be added to the network in order to increase the capacity of the system, limited primarily by the switching capacity of the hubs 14, 16. Similarly, new functions can be migrated onto the network simply by adding new or different worker processes to the client computing resources.

It should be appreciated that the distributed computing system described above would be particularly well suited to numerous real-time applications. By way of example, the distributed computing system could be adapted to operate as a telecommunications server, switch, or Service Switching Point (SSP) that handles the switching of telephone calls between plural trunk lines. As known in the art, narrow band switching signals are communicated between the SSPs to identify destination and other information associated with telephone traffic on the trunk lines. The SSPs receive the switching signal data packets and determine the routing of the telephone traffic in accordance with various routing algorithms. An SSP constructed in accordance with an embodiment of the present distributed computing system may include plural worker processes that execute the algorithms in accordance with a virtual process thread. For example, the SSP may include an input worker process that receives incoming switching signals and writes a corresponding tuple to the tuple space. Another worker process may grab the tuple, perform a first level of processing, and write a modified tuple to the tuple space. Yet another worker process may grab the modified tuple, perform a second level of processing, and write a further modified tuple to the tuple space. Lastly, an output worker process may grab the further modified tuple and produce an outgoing switching signal that controls the routing of the associated telephone call. Many other real time applications would equally benefit from the present distributed computing system, such as Internet protocol hubs, routers, switches, Web servers, voice processors, e-mail servers, and the like. The present distributed computing system is particularly well suited to high availability telecommunications applications since it allows committed transactions to be lost occasionally in favor of recovering the system quickly (i.e., maintaining service availability) in the event of a partial system failure.

In the preceding distributed computing system, which is described in co-pending U.S. patent application Ser. No. 09/548,525, filed on Apr. 13, 2000 and entitled DISTRIBUTED COMPUTING SYSTEM CLUSTERING MODEL PROVIDING SOFT REAL-TIME RESPONSIVENESS AND CONTINUOUS AVAILABILITY, which application is hereby incorporated by reference in its entirety, a primary server 22 and a back-up server 32 provided services to a plurality of clients 42, 44 and 48. In accordance with one aspect of the present invention, it is preferred to provide a distributed computing system that has roving servers.

In the roving server system and process of the present invention, each node runs a server process that determines whether a server is needed. More specifically, if a first server process in a first node determines that a master server is needed, then the first server process in the first node assumes the responsibilities of a master server. If the first server process determines that another server process operating in another node has already assumed the role of a master server, then, the first server process enters a passive state. In the passive state, the first server process determines whether the master server requires a back-up server, and if necessary, the first server process assumes the responsibilities of a back-up server. Thus, the passive servers are preferably “roving” in the sense that they constantly monitor the state of the tuple space, and one of the passive servers becomes a back-up server if no other server is currently a back-up server. In accordance with the present invention, the procedures utilized to determine master and back-up servers are simplified.

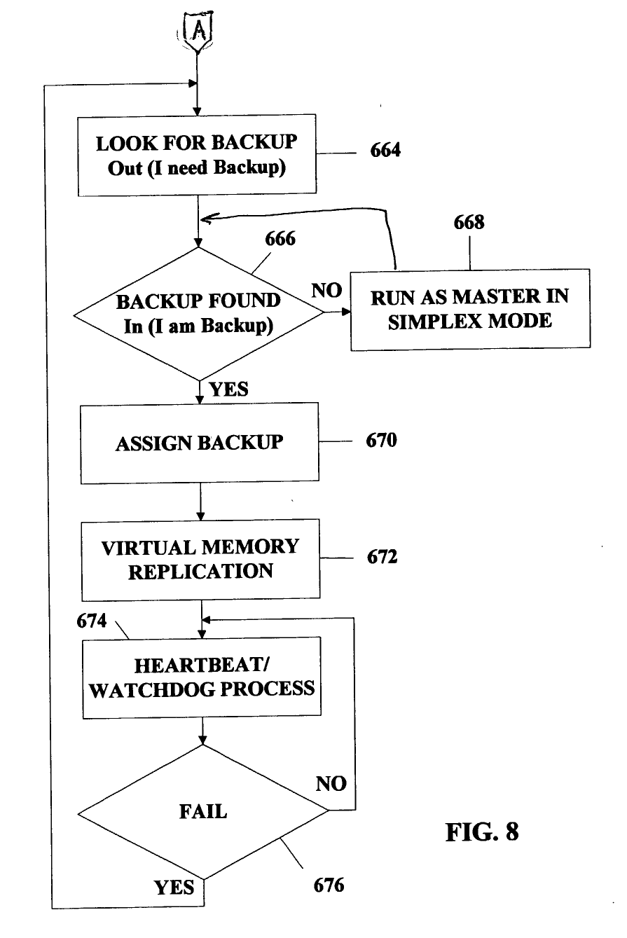

Referring to FIG. 6, a distributed computing system 600 is illustrated. The distributed computing system 600 includes a plurality of computing notes 602 to 609. The nodes 602 to 609 may be workstations, personal computers or any other computing device. Each of the nodes 602 to 609 communicate with a virtual shared memory 610. Further, each of the nodes 602 to 609 are connected via a dual ethernet 612. While a dual Ethernet connection is preferred to allow the system to be robust against interface failures, it is not required. Other connections, or a single connection, can also be used. Communications between the nodes 602 to 609 and with the virtual shared memory 610 are preferably implemented with the application-data-exchange protocol that implements the semantics of tuple space operations and the Linda parallel computational model.

Input and output channels are provided to each of the nodes 602 to 609. However, only input/output channel 614 to the node 608 and input/output channel 615 to the node 604 are illustrated in FIG. 6. A plurality of applications 616 communicate through an application program interface (API) 618 with the nodes 602 to 609 so that each of the applications are run by one or more of the nodes 602 to 609. Each of the nodes 602 to 609 runs a server process that can, depending on the natural load balancing of the system of FIG. 6, assume the responsibility of a master server or the responsibility of a back-up server.

When the distributed computing system starts up, none of the nodes 602 to 609 has a server process that has assumed the role of a server, and therefore none of the server processes in the nodes 602 to 609 function as a server of any kind. Thus, at start-up, there are no master servers and no back-up servers, but a server process in one of the nodes 602 to 609 will assume the responsibilities of a master server and another one of the server processes in the nodes 602 to 609 will preferably assume the responsibilities of a back-up server. To determine which of the server processes in the nodes 602 to 609 will assume the responsibilities of a server, each node 602 to 609 performs a discovery process at start-up.

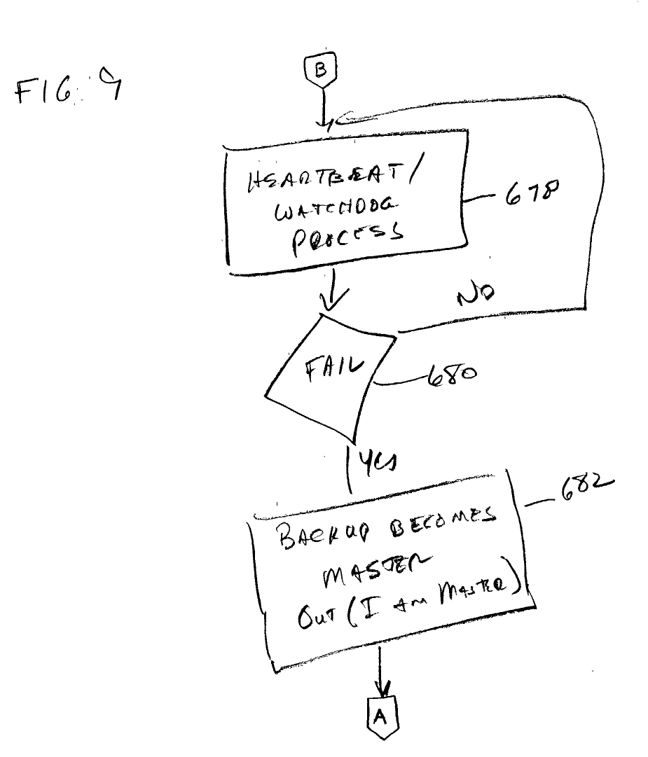

Referring to FIGS. 7 to 9, the steps performed by the discovery process in each of the nodes 602 to 609, after start-up 650, are illustrated. These steps will be described with respect to the discovery process in one node 602, but all of the other nodes 603 to 609 also include a discovery process that perform the same steps to determine whether they should assume the roles of a master server or a back-up server. Thus, each node 602 to 609 preferably has the required discovery process that can determine whether to assume the responsibilities of a master or a back-up server, and also has the required server processes that also perform the responsibilities of a master or a back-up server.

After start-up 650, in step 652, the discovery process in the node 602 looks for the existence of a server process within the distributed computing system 600 that has assumed the responsibilities of a master server. A cluster definition file contains a list of possible nodes that could be the master and a defined discovery port number. As a node starts up, in step 652, it sends a discovery packet to each node defined by the cluster definition file to determine if there is a master server process running. The discovery packets are preferably transmitted between the nodes via UDP datagrams. Only the node having assumed the responsibilities of a master server through its master server process responds to the discovery packet, and all other nodes ignore the packet.

In step 654, if no server process that has assumed the responsibilities of a master server responds, after trying all possible nodes a fixed number of times during the discovery process, then that indicates to the server process in the node 602 that no other server process in the nodes 603 to 609 has assumed the responsibilities of a master server. The preferred number of attempts of all possible nodes is twice during the discovery process, but any fixed number of attempts can be used.

Thus, assuming that no response is received, then the server process in the node 602, in step 656, assumes the responsibilities of a master server. In the distributed communications system 600, as part of step 656, the server process in the node 602 accomplishes this step by creating an internal process that will respond to session initialization messages so that other nodes or processes performing the discovery process will receive a response from a new master server. Any node that assumes the responsibilities of a master server performs this step.

On the other hand, if a response is received during the discovery process, then that indicates that a server process in one of the other nodes 603 to 609 has assumed the responsibilities of a master server. Then the server process in the node 602 enters a passive state in step 658. The node 602 also establishes a link to the tuple space.

In the passive state, the server process in the node 602 attempts to become a back-up server. When the current master needs a backup, it puts out a request, via a tuple, which one of the possibly many passive server process consumes in operation. On consuming the back-up request tuple, a passive server process moves to its back-up mode processing.

Thus, in step 660, the server process in the node 602 has already entered the passive state. The server process is therefore attempting to assume the responsibilities of a back-up server. In the distributed computing system 600 of the present invention, the server process in the node 602 does this by looking in the tuple space in the virtual memory space 610 for a tuple stating that a master server needs a back-up server. For example, the server process looks for the following tuple:

In (Need Backup (Master information elements))

If that tuple is not found, then the passive server 602 will block (or wait) until a “Need Backup(Master information elements)” tuple is present and consumed by this specific instance of a passive server. If no tuple exists, this implies that another node has already assumed the needed backup role for the current master server. This passive server will wait until it is needed as a backup server, typically because either the current backup server has failed or the current master server has failed causing the current backup server to become the master server (simplex mode) and this new server now requests a new backup. Thus, the blocking causes the checking of the tuple space to be persistent over time, so that the passive server 602 can respond at any time. Thus, blocking means the function that does the request will only continue operation once it has gotten a tuple response for the “in” request. So the only way program execution of this specific server process will continue is when it is given a response for the blocking “in” request.

On the other hand, if the server process in the node 602 consumes a tuple indicating that a back-up server is needed, then the server process in the node 602 assumes the role of a back-up server, in step 662. In the distributed computing system 600, this is preferably accomplished by creating a tuple in the virtual memory space that states that the server process in the node 602 has assumed responsibility as a back-up server. For example, in step 662, the server process in the node 602 would preferably create the following tuple:

Out (Backup_response(Backup information elements)).

Returning now to step 656, the server process in the node 602 has already assumed the responsibilities of a master server, and the server process in the node 602 now needs a back-up server. Thus, referring to FIG. 8, in step 664, the server process in the node 602—now the master server—requests a back-up server. In the distributed computing system 600, this is preferably accomplished by creating a tuple into the tuple space in the virtual memory space 610 that indicates a back-up server is needed. In the distributed computing system 600, this is preferably accomplished with the command:

Out (Need_Backup(Master information elements))

The master server, in step 666, looks for a back-up server that has responded and is available. As part of this operation, the master server does a blocking in request for the “Backup_tuple_reponse”, so that when the backup responds to the master request, the master process will unblock and continue the process of getting the backup server populated with current master state information and status.

In step 668, until a backup server response is received, the master server operates in simplex mode. In the simplex mode of operation, the master server operates without a back-up server. If, however, a back-up server is found in step 666, then in step 670, the server process in the node 602 notes that there is a back-up server.

In step 672 the master server and the backup server perform a virtual memory replication process. In this replication process, the tuple space (or the virtual shared memory) in the master server is replicated in the backup server. This replication will allow the back-up server to become a master server in the event of a failure of the master server.

Then, in step 674, the server process in the node 602, that has already assumed the role of a master server, performs a process to continually determine the continued operation and availability of the back-up server. This process can be a traditional watchdog process. It can also be a new heartbeat process, which will be discussed in greater detail later. If the operational checking process should ever indicate that the back-up server has failed in step 676, then the master server will enter simplex mode operation (ie. operation without a back-up), and, in step 664, will request another back-up server, thereby restarting the whole process of entering duplex mode operation.

Referring to FIG. 9, some of the steps performed by a back-up server after the back-up server declares itself as such in step 662 are illustrated. In step 678, the back-up server performs a process to continually check the operational status of the master server. Once again, this process can either be a traditional watchdog process, or the new heartbeat process that will be described in greater detail later.

In step 680, if the operational checking process performed by the back-up server should ever indicate a failure of the master server, then, in step 682, the back-up server becomes the master server. After assuming the role of master server in step 682, the node would then start performing the steps at step 664 to request a new back-up server. On the other hand, if step 680 indicates that the master server is operating, the back-up server routinely or periodically continues to perform the operational check of the master server.

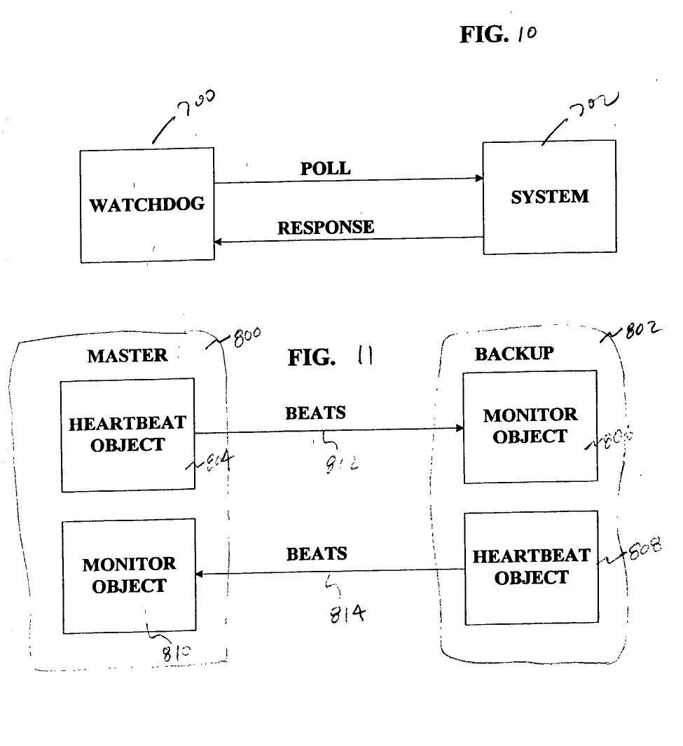

As mentioned previously, a number of different processes, including heartbeat or watchdog processes, may be utilized in the steps 674 and 678. A traditional watchdog process, wherein a monitoring node issues a polling command to the component it wishes to monitor, and waits for a response from the component being monitored, can be used. FIG. 10 depicts such a polling process, wherein a watchdog process 700 polls a system process being monitored 102 and awaits a response.

If the master server were monitoring a back-up server 702 using a watchdog process in step 674, it would issue a calling command to the back-up server. If the backup server were operational, it would then provide a response back to the master server. If the master server received the response, it would consider the back-up server operational. If, on the other hand, no response is received, the master server would consider the back-up server non-operational.

Similarly, if the watchdog process were used in step 678 by the back-up server, the back-up server would issue a calling command to the master server, and if the master server were operational, it would respond. If no response were received, the back-up server would consider the master server non-operational. These watchdog models, however, require extensive error handling code.

It is, therefore, preferred to utilize a heartbeat monitoring system, as illustrated in FIG. 11. In the heartbeat protocol of FIG. 11, four new software objects are implemented. Two of the software objects are performed in the master server node 800. These software objects are a heartbeat object 804 and a monitoring object 810. The other two software objects are performed in the node that is functioning as a backup server 802, and these objects are also a heartbeat object 806 and a monitoring object 808.

The idea in the heartbeat process is to humanize the process by analogizing the process to monitoring the beats of a human heart. Essentially, the heartbeat object beats by repetitively or continually sending an electronic signal out, preferably but not necessarily at a periodic rate, much in the way a heart beats. A monitor object monitors the beat. As long as a beat is detected within a given time interval, the node implementing the heartbeat object is considered to be alive, much in the way a human is alive if there is a heartbeat. Further, the monitoring object need not monitor the beat from the heartbeat object at the same rate that the heartbeat object beats at. Thus, the beating and the monitoring can be asynchronous. Also, while the heartbeat object preferably beats at a periodic rate, the beat is not necessarily periodic. Further, the rate at which the heartbeat is generated and the given time period in which the monitor object has to detect the beat is preferably programmable, and is also system dependent.

In the exemplary heartbeat process of FIG. 11, the master server and the back-up server each implement a heartbeat process. Thus, the back-up server node 802 can implement the heartbeat object 808 by transmitting a periodic beat 814. In the system 600, this could be accomplished by creating a tuple: Out (Back-up_server_beat). Similarly, the master server 800 implements a heartbeat object 804 by transmitting a periodic beat 812. This can be accomplished by creating a tuple: Out(Master_server_beat).

While the use of tuple space to implement the heartbeats 812 and 814 works well, a simpler interface that removes a layer of complexity from the server processes is preferred. Thus, in the preferred embodiment, UDP datagrams are used to transmit the heartbeat information from both the master server and the back-up server. Further, virtually any interface can be used to transmit a heartbeat from one node that can be monitored by another node.

The master server node monitors the beats 814 from the back-up server 802 with the monitor object 810. Similarly, the back-up server 802 monitors the beats 812 from the master server 800 with the monitor object 806. In the system 600, this monitoring function could be accomplished by looking for the above-identified tuple in the virtual memory space 610: In (Back-up_server_beat).

Once again, however, since it is preferred to use UDP datagrams to transmit the heartbeat, the monitoring object preferably also uses UDP datagrams in the monitoring process. Once again, this lowers the complexity level of the interface. It also allows the interface to be given higher priority in the scheduling process, so that the heartbeats will tend to get through even in a congested network condition. Thus, a flood of in/out requests will not slow up the heartbeat generation process.

The master server node then preferably tests for a heartbeat 680. If the master server node does not find the beat within a given time period, which is system definable, then it considers that the back-up server has failed, and then looks for a new back-up server in the manner previously described. If the master server node finds the beat in, then it considers that the back-up server is still operational.

If the back-up server node 802, in step 678, does not find the beat 812 from the master server node 800, then it considers the master server node 800 as having failed, and the back-up server node 802 becomes the new master server, as previously described in step 682. On the other hand, if the back-up server node 802, in step 678, finds the master server node beat 812, then it considers the master server node 800 as being operational.

So, generally, in the heartbeat process, if the monitoring object fails to detect a beat from the heartbeat object just one time, the monitoring object considers that the device implementing the heartbeat object has failed. To further illustrate this concept, if the heartbeat object beats at a rate X, the rate at which the monitoring object monitors for the beat should be selected at the maximum time a system designer wants to wait for the beat to be monitored. So, if the monitoring rate is Y and the beating rate is X, then the monitoring rate Y can be set at any rate greater than the beating rate X. For example, if the system designer is willing to wait two times the period associated with the beating rate X, then the monitoring rate Y can be set at twice the rate of the beating rate X (i.e., 2X). This will allow two beats to come into the monitoring object, but only one is required.

Thus, one of the unique features of the heartbeat concept is that the monitoring object does not need to “count” missed heartbeats, but simply indicates “yes” or “no” (i.e., alive or not), based on whether at least one beat has occurred within the allotted time period of monitoring. This is why the asynchronous nature of setting the beat and monitoring rates is important, as no counting is necessary. Implementing this concept in programming is simple. For example, the programming can simply be “if heartbeat exists, okay and start test over. If no heartbeat, then other side (i.e., the heartbeat object) has failed.”

The master server 800 performs similarly. If the master server 800, in step 674, does not find the beat 814 from the back-up server 802, then it considers the back-up server as having failed, and the master server 800 looks for a new back-up, as previously described in step 664. On the other hand, if the master server 800, in step 674 finds the back-up node beat 814, then it considers the back-up node 802 as being operational.

Having thus described a preferred embodiment of a distributed computing system clustering model, it should be apparent to those skilled in the art that certain advantages of the invention have been achieved. It should also be appreciated that various modifications, adaptations, and alternative embodiments thereof may be made within the scope and spirit of the present invention. The invention is defined by the following claims.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of providing a telecommunication service in a distributed computing system having a plurality of computing nodes, each of the nodes having a server process, a first node having a server process executing as a master server and a second node having a server process executing as a backup server, comprising the steps of:
the master server transmitting a heartbeat;
the backup server monitoring the heartbeat;
if the backup server does not detect the heartbeat within a given time, then the backup server assumes the role of a new master server.

2. The method as claimed in claim 1, further comprising the steps of:
the new master server requesting a new backup server; and
one of the server processes in the plurality of computing nodes assuming the role of a new backup server in response to the request for a new backup server.

3. A distributed computing system having a plurality of computing nodes, each of the nodes having a server process, a first node having a server process executing as a master server and a second node having a server process executing as a backup server, comprising:
means for transmitting a heartbeat from the master server;
means for monitoring the heartbeat signal from the backup server;
means for the backup server assuming the role of a new master server if the backup server does not detect the heartbeat signal within a given time.

4. The system as claimed in claim 3, further comprising:
means for the new master server issuing a command requesting a new backup server; and
means for one of the server processes in the plurality of computing nodes assuming the role of a new backup server.

5. A software monitoring process, comprising the steps of:
repetitively generating a heartbeat from a first node and transmitting the heartbeat from the first node;
monitoring the reception of the heartbeat at a second node; and
the second node determining the operational status of the first node in accordance with the status of the reception of the heartbeat.

6. The software monitoring process as claimed in claim 5, wherein the second node declares the first node operational if the heartbeat is received within a predetermined amount of time.

7. The software monitoring process as claimed in claim 6, wherein the second node declares the first node non-operational if the heartbeat is not received within the predetermined amount of time.

8. The software monitoring process as claimed in claim 5, wherein the first node generates the heartbeat at a first rate and the secured node monitors the reception of the heartbeat at a second rate.

9. The software monitoring process as claimed in claim 8, wherein the first rate and the second rate are asynchronous.

10. The software monitoring process as claimed in claim 5, further comprising the steps of:
repetitively generating a heartbeat at the second node and transmitting the heartbeat generated at the second node from the second node;
monitoring the reception of the heartbeat generated at the second node at the first node; and
at the first node, determining the operational status of the second node in accordance with the status of the reception of the heartbeat generated at the second node.

11. The software monitoring process as claimed in claim 10, wherein:
the second node declares the first node operational if the heartbeat generated at the first node is received within a first predetermined amount of time, but declares the first node non-operational if the heartbeat generated at the first node is not received within the first predetermined amount of time; and
the first node declares the second node operational if the heartbeat generated at the second node is received within a second predetermined amount of time, but declares the second node non-operational if the heartbeat generated at the second node is not received within the second predetermined amount of time.

12. The software monitoring process as claimed in claim 10, wherein the first node generates the heartbeat at a first rate and the second node monitors the reception of the heartbeat generated at the first node at a second rate; and
the second node generates the heartbeat at a third rate and the first node monitors the reception of the heartbeat generated at the second node at a fourth rate.

13. The software monitoring process as claimed in claim 12, wherein the first rate and the second rate are asynchronous and the third rate and the fourth rate are asynchronous.

14. A software monitoring system, comprising:
means for repetitively generating a heartbeat at a first node and transmitting the heartbeat from the first node;
means for monitoring the reception of the heartbeat generated at the first node at a second node; and
means for determining the operational status of the first node at the second node in accordance with the status of the reception of the heartbeat generated at the first node.

15. The software monitoring system as claimed in claim 14, wherein the second node declares the first node operational if the heartbeat generated at the first node is received within a predetermined amount of time.

16. The open-loop software monitoring system as claimed in claim 15, wherein the second node declares the first node non-operational if the heartbeat generated at the first node is not received within the predetermined amount of time.

17. The software monitoring system as claimed in claim 16, wherein the first node generates the heartbeat at a first rate and the secured node monitors the reception of the heartbeat generated at the first node at a second rate.

18. The software monitoring system as claimed in claim 17, wherein the first rate and the second rate are asynchronous.

19. The software monitoring system as claimed in claim 14, further comprising:
means for repetitively generating a heartbeat at the second node and transmitting the heartbeat generated at the second node from the second node;
means for monitoring the reception of the heartbeat generated at the second node at the first node; and
means for determining the operational status of the second node at the first node in accordance with the status of the reception of the heartbeat generated at the second node.

20. The software monitoring system as claimed in claim 19, wherein:
the second node declares the first node operational if the heartbeat generated at the first node is received within a first predetermined amount of time, but declares the first node non-operational if the heartbeat generated at the first node is not received within the first predetermined amount of time; and
the first node declares the second node operational if the heartbeat generated at the second node is received within a second predetermined amount of time, but declares the second node non-operational if the heartbeat generated at the second node is not received within the second predetermined amount of time.

21. The software monitoring system as claimed in claim 17, wherein the first predetermined amount of time is equal to the second predetermined amount of time.

22. The software monitoring system as claimed in claim 19, wherein the first node generates the heartbeat at a first rate and the second node monitors the reception of the heartbeat generated at the first node at a second rate; and
the second node generates the heartbeat at a third rate and the first node monitors the reception of the heartbeat generated at the second node at a fourth rate.

23. The open-loop software monitoring system as claimed in claim 22, wherein the first rate and the second rate are asynchronous and the third rate and the fourth rate are asynchronous.

24. A method of providing a telecommunication service in a distributed computing system having a plurality of computing nodes, one of the plurality of computing nodes operating as a master server and another one of the plurality of computing nodes operating as a back-up server, and each of the plurality of servers being able to operate as a maser server or a back-up server, comprising the steps of:
the back-up server monitoring the operational status of the master server;
the back-up server assuming the role of master server if the master server fails;
the new master server requesting a new back-up server; and
one of the other plurality of computing nodes becoming the new back-up server.

25. The method of claim 24, wherein the back-up server has replicated the memory space in the master server.

26. A distributed telecommunications system having a plurality of computing nodes, one of the pluralities of computing nodes operating as a master server and another one of the plurality of computing nodes operating as a back-up server, and each of the plurality of servers being able to operate as a maser server or a back-up server, comprising:
means for the back-up server to monitor the operational status of the master server;
means for the back-up server assuming the role of master server if the master server fails;
means for the new master server requesting a new back-up server; and
means for one of the other plurality of computing nodes becoming the new back-up server.

27. The system of claim 26, wherein the back-up server has replicated the memory space in the master server.
